(19) United States
(12) Patent Application Publication
(10) Pub. No.: US 2015/0343436 A1
(43) Pub. Date: Dec. 3, 2015

(54) METHOD FOR PREPARING SILICOTITANATE AND CS ADSORBENT

(71) Applicant: KYUNGPOOK NATIONAL UNIVERSITY INDUSTRY-ACADEMIC COOPERATION FOUNDATION, Daegu (KR)

(72) Inventors: Sang June CHOI, Daegu (KR); Young Hun KIM, Daegu (KR); Jong Won JEON, Andong-si (KR); Youn Jin PARK, Daegu (KR)

(21) Appl. No.: 14/317,316

(22) Filed: Jun. 27, 2014

(30) Foreign Application Priority Data
May 28, 2014 (KR) 10-2014-0064518

(51) Int. Cl. B01J 39/14; C01B 39/00; B01J 39/02; C02F 1/28

(52) U.S. Cl. CPC B01J 39/14; C02F 1/281; C01B 39/00; B01J 39/02; C02F 2101/006

(57) ABSTRACT

The present invention provides a method for mass production of silicotitanate at low costs using SiO₂; and a cesium adsorbent containing silicotitanate in which Na⁺ is substituted with H⁺ by acid treatment of Na-silicotitanate. The cesium adsorbent according to the present invention may be used in a filter for purification of air and water, and also as an agent for restoring soil, atmosphere and ocean contaminated with nuclide materials.

### FIELD OF THE INVENTION

The present invention relates to a method for preparing silicotitanate; a cesium adsorbent; a filter for removing cesium; a method for preparing purified water; and a method for treating a radioactive solution.

### BACKGROUND OF THE INVENTION

Nuclear fission products refer to nuclides generated by nuclear fission, or nuclides generated by radioactive decay from such nuclides, and are also abbreviated as FP (Fission Products). Nuclear fission products remain in an aqueous nitric acid acidic solution with a part of transuranium elements in a fuel reprocessing process, and are a main cause of radiation and decay heat generation of high-level radioactive wastes. Most problematic radioactive materials include cobalt-60, strontium-90 and cesium-137.

Cesium-137 is one of the isotopes of cesium, an alkali metal element having an atomic number of 55, and is an artificial radioactive nuclide. Cesium-137 has a half-life of 30.2 years, and is decayed to stable Ba-137 after radiating rays (0.662 MeV). Cesium-137 is included in liquid wastes of nuclear power plants and the like thereby is an important nuclide as a target of radiation exposure evaluations of surrounding environments. Meanwhile, Cesium-137 is discovered as an important nuclide in fallout occurred due to nuclear tests. When Cesium-137 accumulates in the body, it is reduced by half in 70 to 80 days due to excretion by metabolism, and the like.

Meanwhile, radioactive nuclide wastewater is considered as radioactive wastes even when a very low concentration of radioactive materials is included, and very complicated management and treatment procedures are required. Such radioactive nuclide wastewater is generally treated using methods such as an evaporation method, a membrane filtration method and an ion exchange method.

Among these, the evaporation method has a disadvantage that all the wastes remaining after evaporating all the moisture need to be treated. In addition, the membrane filtration method and the ion exchange method are non-selective treatment methods, and the methods that remove non-radioactive salts such as sodium, calcium and potassium present with radioactive nuclides at the same time. The concentration of nuclide materials are very low compared to the concentration of non-radioactive salts, therefore, all soluble materials present in waste liquids need to be removed in order to remove small amounts of radioactive salts, and consequently, the costs are high.

Accordingly, studies on adsorbents selectively adsorbing only radioactive nuclides have been carried out in radioactive nuclide wastewater treatment, and a material called silicotitanate is recently known to be capable of selectively adsorbing cesium and the like.

Synthesis methods of silicotitanate published in articles and the like use liquid raw materials such as tetraethylorthosilicate and titanium isopropoxide, and these raw materials have a disadvantage that they are difficult to handle and are high-priced, and as a result, the product unit costs are high. In addition, existing raw materials have a disadvantage that the content for silica is low, therefore, a large volume reactor is required compared to when high-density solid raw materials are used. Accordingly, the use of solid raw materials that are easy to obtain and easy to handle, such as silica gel, may be considered, however, they have disadvantages in that mixing is difficult compared to existing liquid raw materials, and the produced adsorbent has low adsorptivity and low selectivity as well.

### SUMMARY OF THE INVENTION

An objective of the present invention is to provide silicotitanate of which cesium (Cs) selectivity is improved.

Another objective of the present invention is to provide a method for mass producing silicotitanate at low costs.

A first aspect of the present invention provides a method for preparing silicotitanate including a first step of mixing SiO₂, TiO₂, NaOH and H₂O to have a molar ratio of SiO₂:TiO₂ ranging from 1.1:1 to 1.5:1; and a second step of hydrothermally synthesizing the mixture of the step 1 at a temperature of 90° C. to 180° C.

A second aspect of the present invention is to provide a cesium adsorbent containing silicotitanate in which Na⁺ is substituted with H⁺ by the acid treatment of Na-silicotitanate.

A third aspect of the present invention is to provide a filter for removing cesium provided with the cesium adsorbent according to the second aspect.

A fourth aspect of the present invention is to provide a method for preparing purified water including a step of passing contaminated water through the filter for removing cesium according to the third aspect.

A fifth aspect of the present invention is to provide a method for treating a radioactive solution including a step of removing radioactive cesium by passing a solution including radioactive waste liquids or radioactive nuclides through the filter for removing cesium according to the third aspect.

### BRIEF DESCRIPTION OF THE DRAWINGS

FIG. 1 is a basic skeleton structure of ETS series silicotitanate.

FIG. 2 shows a picture of a high temperature high pressure reactor capable of being used in silicotitanate synthesis according to the present invention.

FIG. 3 is a picture of silicotitanate powder synthesized and acid-cleaned in Example 1.

FIG. 4 is a graph showing an adsorption treatment result of Na-silicotitanate synthesized in Example 1 used as an adsorbent for radioactive nuclide ions.

FIG. 5 is a graph showing an adsorption treatment result for radioactive nuclide ions after acid cleaning Na-silicotitanate synthesized in Example 1.

FIG. 6 shows synthesis processes of Na-silicotitanate and K-silicotitanate used in Experimental Example 3 by a diagram.

### DETAILED DESCRIPTION OF THE EMBODIMENTS

Hereinafter, the present invention will be described in detail.

Na, K, Nb and the like are structure stabilization ions of titanium silicate, and the presence of these ions is important in the synthesis since these ions are ion-exchanged with radioactive nuclide ions.

Na-silicotitanate is a synthetic inorganic material having a tetragonal crystal structure, which is the same as natural sitinakite, ideally has a chemical formula of Na₂Ti₂O₃SiO₄.2H₂O with the Ti—O forming an octahedral and the Si—O forming a tetrahedral structure being laminated in a crystallographic c-axis direction (refer to FIG. 1). A long tunnel created along the c-axis is formed by TiO₆ being laminated in a ridge-sharing form, Na⁺ ions are distributed between the inside of this tunnel and SiO tetrahedral lamination, and interstitial solid dissolution of radioactive ions selectively occurs by the ion exchange with the Na⁺ ions. This structure shows particularly high efficiency in treating multi nuclides and ions such as Co²⁺, Sr²⁺, Cs⁺ and Ca²⁺. However, Na-silicotitanate is identified to have no selective ion exchange capacity for monovalent and divalent cations.

The inventors of the present invention have sought for a post-treatment method to allow silicotitanate to have a selective ion exchange capacity for Cs, since the treatment of Cs that emits γ-radiation rays is most difficult radioactive materials causing contamination. It has been discovered that when an H-form is formed by an ion exchange manner after post treating Na-silicotitanate with acids, the selectivity for monovalent cations increases. In summary, the inventors of the present invention have discovered that when Na-silicotitanate is acid-treated, adsorptivity and selectivity for a radioactive nuclide (Cs) increase due to the changes in structural characteristics. The present invention is based on this discovery.

Meanwhile, a titanium silicate material is a large pore material having a pore size of from 4 Å to 8 Å, and synthesized by hydrothermal synthesis under an alkaline condition, such as an existing aluminosilicate zeolite. However, its synthesis is difficult due to the very limited crystallization area, and particularly, alkalinity of reactants and a titanium source are known to very sensitively affect the phase and the purity of the final product.

The synthesis method of Na-silicotitanate (Cllearfield, 2006) has an advantage that the synthesis may be carried out in a short time and in a relatively simple manner, however, there are disadvantage that the costs are high in actual field-scale applications since the reagents used in the synthesis are high-priced. Accordingly, the inventors of the present invention have carried out studies on the synthesis of Na-silicotitanate using solid-phased fumed silica (Aldrich) available at a relatively low price instead of liquid-phased tetraethylorthosilicate as a Si-supplying material among the high-priced reagents, and tried the synthesis with the composition ratio of TiO₂:SiO₂:Na₂O:H₂O=1:1:4:146, which is used in existing synthesis methods but changing the Si source, however, the synthesis was not successful. In addition, Na-titanium silicate has a narrow formation area for synthesis, and thus the synthesis of a material having pure crystals is difficult. Consequently, it has been discovered that, due to the low compatibility and/or reactivity of SiO₂ compared to tetraethylorthosilicate, Na-silicotitanate can be synthesized when the amount of added SiO₂ increases by from 0.1 to 0.5 times, preferably 0.3 to 0.4 time, and when the hydrothermal synthesis is carried out in a sealed reactor. In this case, an adsorbent having a similar or better ion exchange capacity compared to existing adsorbents is synthesized, and silicotitanate having crystallizability is secured. The present invention has its basis on the above discovery.

The silicotitanate according to the present invention may be prepared using a preparation method including a first step of mixing SiO₂, TiO₂, NaOH and H₂O so that the molar ratio of SiO₂:TiO₂ ranges from 1.1:1 to 1.5:1, and preferably ranges from 1.3:1 to 1.4:1; and a second step of hydrothermally synthesizing the mixture of the first step at a temperature of 90° C. to 180° C.

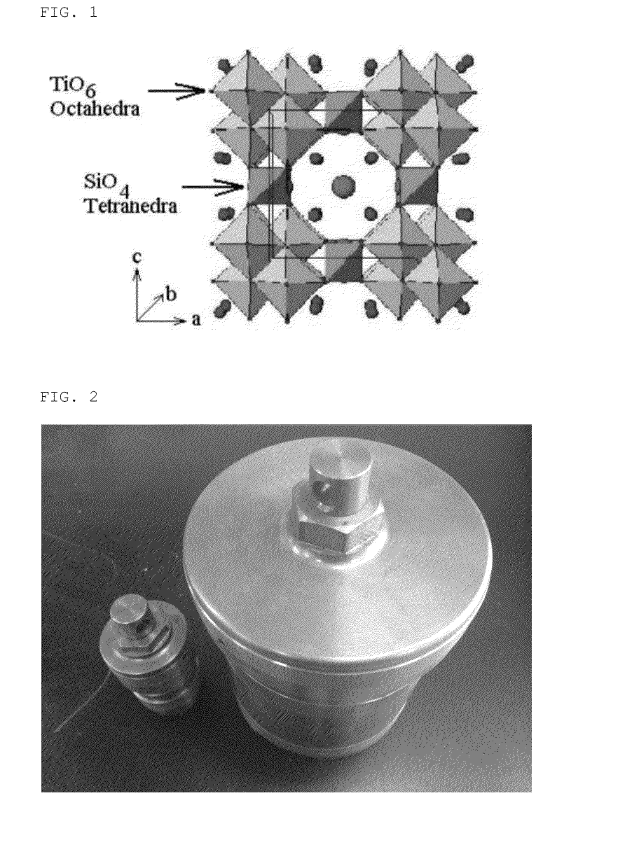

In the hydrothermal synthesis, a sealed reactor such as that shown in FIG. 2 by a diagram may be used.

The method for preparing silicotitanate according to the present invention may be hydrothermal synthesis at a low temperature such as 90° C. to 180° C., and preferably 90° C. to 160° C. When the temperature is lower than 90° C. the yield for the synthesis decreases.

The first step is a step of mixing SiO₂, TiO₂, NaOH and H₂O, which are raw materials of silicotitanate, a material to prepare, and as important raw materials, SiO₂ and TiO₂ are used. The present invention uses SiO₂ in excess (molar ratio) compared to TiO₂.

In the present invention, the added amount of SiO₂ is increased compared to TiO₂ based on the fact that SiO₂, a low-cost and high-density solid raw material, has a low reactivity, and the synthesis is carried out under high pressure in a sealed reactor to facilitate the mixing, and consequently, a low reactivity of the solid raw material may be overcome. In addition, by using high-density materials, approximately 1.5 to 2 times of silicotitanate may be synthesized compared to existing methods even when a reaction vessel of the same volume is used, and therefore, high production efficiency may be obtained in mass production.

Examples of SiO₂ include fumed silica and silica gel.

In addition, the molar ratio of TiO₂ and NaOH is preferably 1:8.

The hydrothermal synthesis time in the second step preferably ranges from 48 hours to 72 hours.

In addition, the second step is preferably carried out under an atmosphere ranging from 0.1 to 0.5 atm.

The method for preparing silicotitanate according to the present invention may further include a third step of acid treating the Na-silicotitanate formed in the second step.

The Na-silicotitanate formed in the second step has Na⁺ (originated from NaOH) as an internal cation, and when this Na⁺ is substituted with H⁺, selective adsorbability of silicotitanate for Cs ions may increase.

In the present invention, the internal cation Na⁺ of the synthesized silicotitanate is exchanged with H⁺ by acid cleaning, and the selectivity for Cs changes depending on the acid concentration used, and the selectivity generally increases as the concentration increases. The preferable acid concentration ranges from 0.1 to 1.0 M, more preferable acid concentration ranges from 0.5 to 1.0 M, and particularly preferable acid concentration is 1.0 M. As the acid, all acids capable of giving H⁺ may be used, and specific examples thereof include nitric acid, hydrochloric acid, sulfuric acid or phosphoric acid.

Meanwhile, the cesium adsorbent according to the present invention contains silicotitanate in which Na⁺ is substituted with H⁺ by the acid treatment of Na-silicotitanate.

The cesium adsorbent according to the present invention may be prepared using the method for preparing Na-silicotitanate according to the present invention. However, Na-silicotitanate may be prepared according to existing Na-silicotitanate synthesis methods except for the acid treatment.

The cesium adsorbent according to the present invention has been confirmed to increase the selective adsorbability for Cs ions when Na-silicotitanate synthesized using other methods as well as Na-silicotitanate prepared using the preparation method according to the present invention is acid-treated (Experimental Example 2).

The cesium adsorbent containing silicotitanate in which Na⁺ is substituted with H⁺ by the acid treatment of Na-silicotitanate according to the present invention may be used in a filter for removing cesium such as a filter for water purification or a filter for air purification.

Herein, an average diameter of the silicotitanate particles may range from 1 μm to 300 μm, and the filter may be provided with a filter membrane having a silicotitanate particle non-permeable mesh size. Nonlimiting examples of the filter membrane include ultrafiltration membrane (UF).

In addition, purified water may be prepared by treating contaminated water using the filter for removing cesium according to the present invention. Herein, there is an advantage that radioactive cesium is mostly removed, and ions beneficial to the body are not removed.

Moreover, radioactive cesium may be removed from a solution including radioactive waste liquids or radioactive nuclides using the filter for removing cesium according to the present invention.

Hereinafter, exemplary examples of the present invention will be described. However, the following examples are for illustrative purposes only, and the present invention is not limited to the following examples.

### Example 1

SiO₂ (fumed silicate, Aldrich):TiO₂:NaOH:H₂O, which are raw materials, are mixed in the molar ratio of 1.3:1:8:146, respectively, for the synthesis of silicotitanate, and herein, NaOH was dissolved in water and used as an aqueous solution. The raw material mixing was carried out for approximately 4 hours in a vessel made of Teflon. Apparatuses made of Teflon were all used in order to prevent additional reactions.

After the mixing, water present at the top was removed, and hydrothermal synthesis was carried out over 72 hours at 160° C. in an oven (autoclave). The synthesized silicotitanate was washed using water and methanol and dried.

The synthesized silicotitanate was identified to have crystallizability when the crystallizability was analyzed using XRD and SEM.

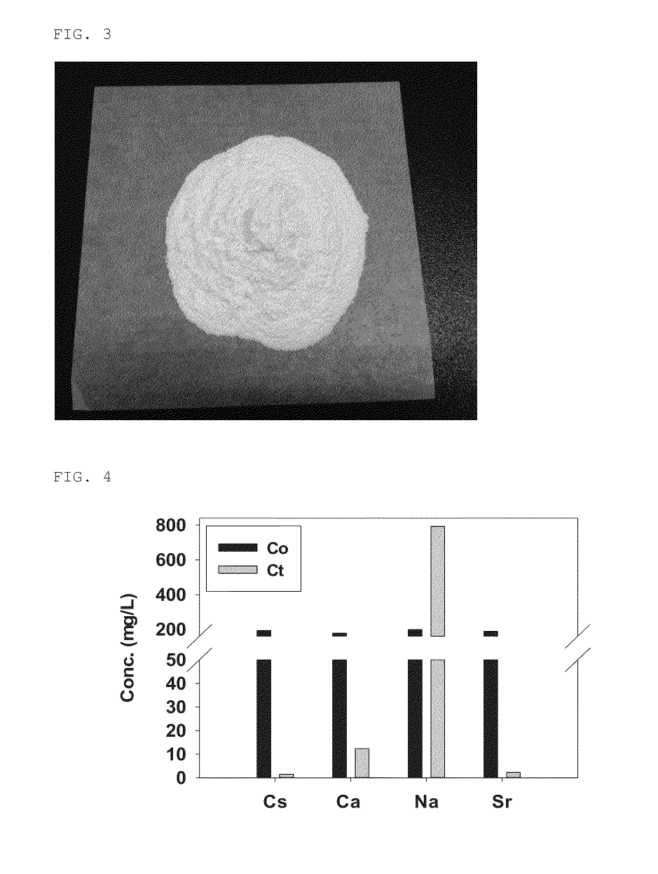

In addition, ion exchange was generated by mixing 0.5 g of the synthesized silicotitanate and each of aqueous HNO; solutions having concentrations of 0.1 M, 0.5 M and 1.0 M for 2 hours. The mixed liquid was centrifuged using a centrifuge, the residual acid was washed using ultrapure water, and the result was filtered through a filter paper and dried (FIG. 3).

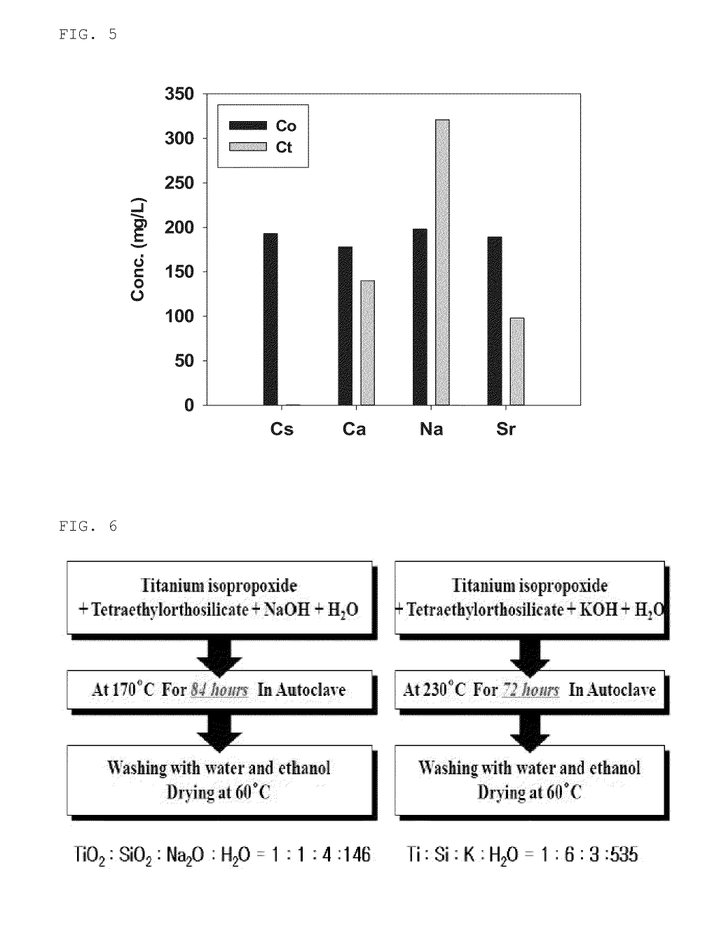

Experimental Example 1 Adsorption tests for Cs, Sr, Cd and Cu present in wastewater were carried out using the silicotitanate prepared in Example 1. The tests were carried out preparing arbitrary wastewater without using real wastewater. CsCl, SrCl₂, Cd(NO₃)₂, CuSO₄, NaCl and CaCl reagents were used, and 0.1 g of the silicotitanate prepared in Example 1 and 10 ml of mixed waste liquid were injected to a 15 ml-sized reaction vessel. After the mixture was reacted for 2 hours, the concentration of each ion was measured. FIGS. 4 and 5 are graphs showing the adsorption treatment results for heavy metals and radioactive nuclide ions using the Na-silicotitanate and the acid-treated Na-silicotitanate, respectively, which were prepared in Example 1.

### Experimental Example 2

The results of the acid treatment of the Na-silicotitanate with HCl are shown in Table 1. The amount of desorbed Na increased in accordance with acid concentrations, and changes in the silicotitanate crystals were not observed when examining through XRD.

TABLE 1

| Acid | Removal Rate (%) | | | | | |
|---|---|---|---|---|---|---|
| Concentration | Cs | Sr | Ca | K | Rb | Li |
| Existing | 86.01 | 77.56 | 78.42 | 51.57 | 67.77 | 9.86 |
| Concentration | | | | | | |
| 0.1M HCl | 98.29 | 73.32 | 75.34 | 52.55 | 95.40 | 8.92 |
| 0.5M HCl | 96.58 | 37.88 | 53.81 | 61.70 | 89.70 | 15.04 |
| 1M HCl | 91.87 | 22.87 | 50.60 | 71.73 | 83.15 | 11.67 |

Results of Na-silicotitanate adsorption after the acid treatment with HCl

As shown in Table 1, it is considered that the structural internal channel of the silicotitanate changes to a form having a charge suited for monovalent cations with the cation site changing to an H-form by the Na, an internal cation, being desorbed by an acid in the Na-silicotitanate.

### Experimental Example 3

As acid treatment targets, Na-silicotitanate having adsorption rates of 99.83, 99.65 and 99.33% or greater with Sr²⁺, Cs⁺ and Ca²⁺, respectively, and K-silicotitanate having adsorption rates of 18.14, 82.32 and 0% with Sr²⁺, Cs⁺ and Ca²⁺, respectively, were used. The processes of synthesizing Na-silicotitanate and K-silicotitanate are shown in a flow chart in FIG. 6.

The Na-form has an overall excellent capability for all nuclide materials, and the K-form exhibits selective adsorption effects for Cs⁺. The silicotitanate property changes due to the acid cleaning were identified by acid cleaning this nano-absorbent, and examining the crystallizability changes and evaluating the radioactive nuclide material removal rates. The concentrations of the nitric acid used were 5 M, 2 M, 1 M, 0.5 M, 0.1 M, 0.25 M, 0.025 M and 0.0025 M. 0.5 g of the synthesized Na- and K-silicotitanate and an acid solution of each concentration were mixed for 2 hours, and centrifuged using a centrifuge. The residual acid was washed using ultrapure water, and then the result was filtered using a filter paper and dried.

Radioactive nuclide removal tests were carried out, and the crystal structure changes after the acid treatment were examined.

When XRD patterns of the Na- and the K-silicotitanate before the acid treatment were examined, it was identified that a ST form and a STOS form coexisted.

In the acid-treated Na-silicotitanate, the adsorption rate for Cs⁺ did not show much change from the initial adsorption rate regardless of the acid concentration.

However, as the acid concentration was gradually closed to 1 M, the adsorption rate for Sr²⁺ and Ca²⁺ gradually decreased, and when cleaned with a 1 M acid, each adsorption rate decreased up to 4.35 and 9.21%. In addition, XRD patterns showed that the STOS main peak gradually decreased as the acid concentration increased, and the STOS main peak was rarely seen when treated with a 1 M acid. However, the ST main peak showed no changes regardless of acid treatment.

TABLE 2

| Acid | Removal Rate: % | | |
|---|---|---|---|
| Concentration | Cs | Ca | Sr |
| 1M | 99.13 | 9.21 | 4.35 |
| 0.5M | 98.99 | 10.27 | 5.41 |
| 0.1M | 99.08 | 95.89 | 99.43 |
| 0.025M | 98.46 | 98.79 | 99.50 |
| 0.0025M | 99.83 | 69.84 | 93.76 |

Ion exchange capacity of Na-Silicotitanate acid treatment

K-silicotitanate did not show much change in the structure and adsorptivity before and after the acid treatment, and the K-form synthesized according to FIG. 6 had selective adsorptivity for Cs⁺.

Generally, Na⁺ in Na-silicotitanate is present as an ion stabilizing the skeleton structure. Superior ion exchange capacity is exhibited due to the presence of this ion, and as Sr²⁺ and Ca²⁺, cations having a similar radius as Na⁺, enter into the channel of the STOS skeleton structure, an ion exchange with Na⁺ ions occurs. When this result is compared with the change of Na⁺ concentration in the silicotitanate adsorption removal test before the acid treatment, the amount of Na⁺ being ion exchanged and desorbed as a solution decreases as the amount of Sr²⁺ and Ca²⁺ adsorption decreases with the decrease of the STOS structure. Meanwhile, when the acid treatment was carried out for selective adsorption, the adsorptivity of Sr²⁺ and Ca²⁺ decreased as the main peak of the STOS structure decreased with the increase of acid concentration, and the adsorptivity of Cs⁺ did not change. The ST structure did not change regardless of acid cleaning, and the ST structure was unstable since cations are not present. However, judging from a D-value of the ST structure, the channel diameter of the skeleton structure is large, and therefore, Sr²⁺ and Ca²⁺ among nuclide materials pass through the channel without binding as an internal cation material in the in addition, ST structure. This is due to the fact that, when the Sr²⁺ and the Ca²⁺ adsorption rates and the Na⁺ ion desorption rate of each silicotitanate are compared, the adsorption and desorption amounts appear to be similar. Consequently, STOS is shown to have almost no effects on Cs⁺ because Cs⁺, due to its radius being similar to the size of the inside of the ST channel, tends to enter into the channel, and Cs⁺ is acting as a cation stabilizing the structure.

A method for preparing silicotitanate according to the present invention is capable of mass production using solid raw materials that are high density, easy to handle and low-priced. In addition, the method has an advantage that only cesium nuclide ions are selectively removed in a highly toxic radioactive waste liquid by improving adsorptivity and selectivity through acid cleaning, and enables to provide a more advantageous preparation method when mass production is necessary in a short period of time, such as in the Fukushima accident.

In addition, a cesium adsorbent according to the present invention may be applied to a filter for water purification and a filter for air purification, and are capable of being used as an agent for restoring contamination of soil, atmosphere and ocean contaminated with nuclide materials.

1. A method for preparing silicotitanate comprising:
a first step of mixing SiO₂, TiO₂, NaOH and H₂O at a molar ratio of SiO₂:TiO₂ ranging from 1.1:1 to 1.5:1; and
a second step of hydrothermally synthesizing the mixture of step 1 at a temperature of 90° C. to 180° C.

2. The method for preparing silicotitanate of claim 1, further comprising a third step of acid treating Na-silicotitanate formed in the second step.

3. The method for preparing silicotitanate of claim 2, wherein the molar ratio between SiO₂ and TiO₂ in the first step ranges from 1.3:1 to 1.4:1.

4. The method for preparing silicotitanate of claim 2, wherein the temperature during the hydrothermal synthesis in the second step ranges from 90° C. to 160° C.

5. The method for preparing silicotitanate of claim 2, wherein a time of hydrothermal synthesis ranges from 48 hours to 72 hours.

6. The method for preparing silicotitanate of claim 2, which uses hydrochloric acid, sulfuric acid, nitric acid or phosphoric acid in the acid treatment.

7. The method for preparing silicotitanate of claim 2, wherein an acid concentration used in the acid treatment ranges from 0.1 to 1.0 M.

8. The method for preparing silicotitanate of claim 2, wherein the SiO₂ is fumed silica.

9. The method for preparing silicotitanate of claim 2, wherein the molar ratio of TiO₂:NaOH is 1:8.

10. A cesium adsorbent containing silicotitanate in which Na⁺ is substituted with H⁺ by the acid treatment of Na-silicotitanate.

11. The cesium adsorbent of claim 10, wherein the Na-silicotitanate is prepared according to the method of claim 1.

12. A filter for removing cesium provided with the cesium adsorbent of claim 10.

13. The filter for removing cesium of claim 12, wherein the filter is a filter for water purification or a filter for the air purification.

14. The filter for removing cesium of claim 12, wherein the filter membrane has a mesh size impermeable to silicotitanate particles.

15. The filter for removing cesium of claim 14, wherein an average diameter of the silicotitanate particles ranges from 1 μm to 300 μm.

16. A method for preparing purified water comprising a step of passing contaminated water through the filter for removing cesium of claim 12.

17. A method for treating a radioactive solution comprising a step of removing radioactive cesium by passing a solution including radioactive waste liquids or radioactive nuclides through the filter for removing cesium of claim 12.

18. The method for preparing silicotitanate of claim 1, wherein the molar ratio between SiO₂ and TiO₂ in the first step ranges from 1.3:1 to 1.4:1.

19. The method for preparing silicotitanate of claim 1, wherein the SiO₂ is fumed silica.

20. The method for preparing silicotitanate of claim 1, wherein the molar ratio of TiO₂:NaOH is 1:8.
